(19) United States
(12) Patent Application Publication
(10) Pub. No.: US 2009/0219443 A1
(43) Pub. Date: Sep. 3, 2009

(54) VIDEO SIGNAL PROCESSING APPARATUS, AND DIGITAL TELEVISION BROADCAST RECEIVER CONTROLLING METHOD

(75) Inventor: Takahiro Kimura, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/325,998

(22) Filed: Dec. 1, 2008

(30) Foreign Application Priority Data
Feb. 29, 2008 (JP) 2008-051190

(51) Int. Cl. H04N 5/57; H04N 5/455; H04N 5/445

(52) U.S. Cl. 348/687; 348/726; 725/39; 348/E05.113; 348/E05.119

(57) ABSTRACT

According to an embodiment, an apparatus has a receiving module which receives a broadcast signal and obtains a receiving signal, a demodulating and signal processing module which demodulates and processes the receiving signal, and converts the signal to a displaying signal, a program table information processing module which obtains broadcast program information, and creates information for displaying a program table, and an on-air screen adjustment module which outputs first video setting information for video setting such as brightness and tone for the displaying signal of the on-air program signal output from the modulating and signal processing module, according to an operation input. The apparatus further has an independent program table screen adjustment module which performs video setting such as brightness and tone for the program table displaying signal output from the program information processing module, according to an operation input.

### CROSS-REFERENCE TO RELATED APPLICATIONS

This application is based upon and claims the benefit of priority from Japanese Patent Application No. 2008-051190, filed Feb. 29, 2008, the entire contents of which are incorporated herein by reference.

### BACKGROUND

1. Field

One embodiment of the present invention relates to a video signal processing apparatus, and a digital television broadcast receiver controlling method. In particular, the invention relates to a method of controlling display of comments and program table.

2. Description of the Related Art

A television broadcast receiver is provided with a function of displaying a television program guide and menu as a graphical user interface (GUI). A television program guide acquires program information from digital data sent from a broadcast station, creates an electronic program guide (ERG) based on the program information, and temporarily saves it in a memory (e.g., Jpn. Pat. Appln. KOKAI Publication No. 2006-262031). The electronic program guide is displayed on a display unit through an on-screen display (OSD) in response to an operation signal. The contents of the electronic program guide are updated periodically or based on setting conditions.

When a display mode is changed from the above electric program guide to a normal program, there arises a problem that the screen brightness of the electronic program guide is too high. To solve this problem, in the prior art, the backlight brightness is automatically lowered interlocking with the display mode change.

However, a technique to lower brightness of the electronic program guide to a specified level includes a problem that the electronic program guide becomes unclear in some places to set the receiver.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view showing an exemplary configuration of a digital television broadcast receiver to which the present invention is adopted;

FIG. 2 is a view explaining a remote controller of the digital television broadcast receiver in FIG. 1;

FIGS. 3A to 3C are exemplary views showing screens of a display unit when a program table screen of the apparatus of the present invention is adjusted;

FIGS. 4A to 4C are exemplary views for explaining screens of a display unit when a program table screen of the apparatus of the present invention is adjusted;

FIG. 5 is a view showing an exemplary configuration of a digital television broadcast receiver according to another embodiment of the invention;

FIG. 6 is an exemplary view of a configuration of essential parts of another embodiment of the invention; and

FIG. 7 is an exemplary view of a configuration of essential parts of further embodiment of the invention.

### DETAILED DESCRIPTION

Various embodiments according to the invention wills be described hereinafter with reference to the accompanying drawings.

A summary of an embodiment is follows.

An object of an embodiment related to the present invention is to provide a digital television broadcast receiver, which is configured to optionally set brightness to an appropriate level on a GUI display such as an electronic program guide, and a method of controlling the receiver.

According to one aspect of the embodiment, there is provided an apparatus comprising a first signal processing module configured to process dynamic image content signal; a second signal processing module configured to process static image content signal for multiplexing them with the dynamic image content signal or displaying them independently; a first screen adjustment module configured to output first video setting information for video setting such as brightness and tone for the dynamic image content signal according to an operation input; a second screen adjustment module configured to output second video setting information for individually setting brightness and tone according to an operation input; and a video processing module configured to display the dynamic image content signal by using the first video setting information, and to display the image information signal by using the second video setting information.

According to the above means, a character screen and a program table screen are adjusted to appropriate brightness independently of an on-air screen. Further, the user individually adjusts these screens to appropriate states according to places to set the apparatus.

Hereinafter, embodiments of the present invention will be explained by referring to the drawings. At first, we will explain an outline of a broadcast receiver to which the present invention is adopted.

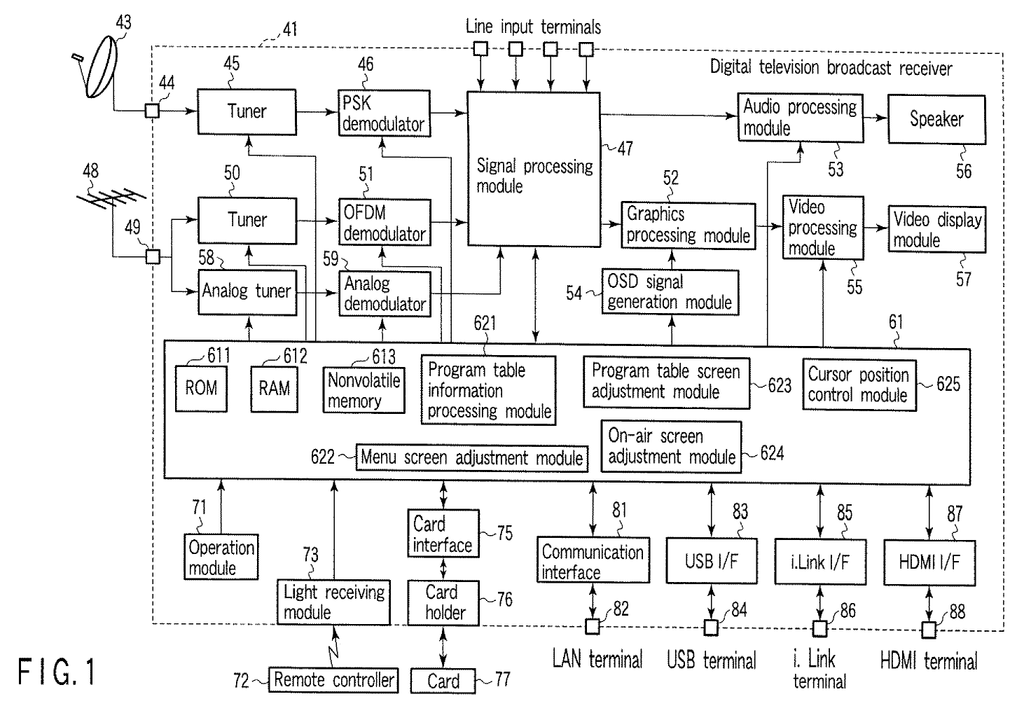

FIG. 1 shows a main signal processing system of a digital television broadcast receiver 41 described above. An antenna 43 for BS/OS digital broadcasting receives a satellite digital television broadcast signal. The received broadcast signal is supplied to a satellite digital broadcast tuner 45 through an input terminal 44, thereby a broadcast signal of a desired channel is selected.

The broadcast signal selected by the tuner 45 is supplied to a phase shift keying (PSK) demodulator 46, and demodulated to digital video and audio signals, and the signals are sent to a signal processing module 47.

An antenna 48 for a terrestrial digital broadcast receives a terrestrial digital television broadcast signal. The received broadcast signal is supplied to a terrestrial digital broadcast tuner 50 through an input terminal 49, thereby a broadcast signal of a desired channel is selected.

The broadcast signal selected by the tuner 50 is supplied to an orthogonal frequency division multiplexing (OFDM) demodulator 51, and demodulated to digital video and audio signals, and the signal are sent to the signal processing module 47.

An analog tuner 58 for receiving a terrestrial analog signal is also provided. A signal received by the analog tuner 55 is demodulated by an analog demodulator 59f and applied to the signal processing module 47.

The signal processing module 47 selectively performs predetermined digital signal processing for the digital video and audio signals supplied from the PSK demodulator 436, OFDM demodulator 51, analog demodulator 59 and line input terminal, and outputs the processed signals to a graphics processing module 52 and an audio processor 53.

The graphics processing module 52 has a function of superposing an OSD signal generated by an on-screen display (OSD) signal generator 54 on the digital video signal supplied from the signal processing module 47. The graphics processing module 52 can selectively output the video signal output of the signal processing module 47 and OSD signal output of the OSD signal generator 54, and can combine these two signals so that each of them constitutes a half of a screen.

The digital video signal output from the graphics processing module 52 is supplied to a video processing module 55. The video processing module 55 converts the input digital video signal to an analog video signal of a format displayable on a video display unit 57, and outputs and displays the converted video signal on the video display unit 57

The audio processor 53 converts the input digital audio signal to an analog audio signal of a format reproducible through a speaker 56, and outputs and reproduces the converted audio signal through the speaker 56.

All operations of the digital television broadcast receiver 11 including the above-mentioned various receiving operations are collectively controlled by a control module 61.

The control module 61 is incorporated with a central processing unit (CPU). When operation information is received from an operation module 71, or when operation information sent from a remote controller 72 is received from a light-receiving module 73, the control module 61 collectively controls each part so that the nature of operations is reflected in the apparatus.

In this case, the control module 61 mainly uses a read-only memory (ROM) 611 storing a control program executed by the CPU, a random access memory (RAM) 612 providing a work area for the CPU, and a nonvolatile memory 613 storing various kinds of setting and control information.

The control module 61 is connected to a card holder 76, into which a first memory card 77 can be inserted through a card interface 75. Therefore, the control module 61 can send/receive information to/from the first memory card 77 inserted into the card holder 76, through the card interface 75. The control module 61 may be connected to a card holder, into which a second memory card can be inserted, through another not-shown card interface.

The control module 61 is connected to a first LAN terminal 82 through a communication interface 81. Therefore, the control module 61 can send/receive information to/from a LAN-compatible hard disc drive (HUD) connected to the first LAN terminal 82, through the communication interface 81. In this case, the control module 61 has a Dynamic Host Configuration Protocol (DHCP) server function, and effects control by assigning an Internet Protocol (IP) address to the LAN-compatible HDD connected to the first LAN terminal. The control module 61 may be connected to a second LAN terminal through another not-shown communication interface.

The control module 61 is connected to a USB terminal 84 through a USE interface 83. Therefore, the control module 61 can send/receive information to/from each unit connected to the USE terminal 84, through the USE interface 83.

The control module 61 is connected to an i. Link (registered trademark) terminal 86 through an i. Link (registered trademark) interface 85. Therefore, the control module 61 can send/receive information to from each unit connected to the i. Link terminal 86, through the i. Link interface 85.

The control module 61 can send/receive information to/from each unit connected to a HDMI terminal 88, through a HDMI interface 87 conforming to the High-Definition Multimedia Interface (HDMI) standard.

The control module 61 has a program table information processing module 621 for processing program information, and a menu information processing module 622. As explained in detail later, the control module 61 includes a program table screen adjustment module 623 for controlling a program table display state, and an on-air screen adjustment module 624. The control module 61 further includes a cursor position control module 625 for controlling cursor movement positions when the user operates the apparatus through the remote controller 72. Each block in the control module 61 may consist of software.

The signal processing module 47 constitutes a first signal processing module for processing dynamic image content signals. The graphics processing module 52 and OSD signal generation module 54 compose a second signal processing module for processing static image content signals for multiplexing them with the dynamic image content signals or displaying them independently.

The on-air screen adjustment module 624 constitutes a first screen adjustment module, which outputs a first video setting information or video setting such as brightness and tone for the dynamic image content signals according to an operation input. The menu screen adjustment module 622 and program table screen adjustment module 623 compose a second screen adjustment module, which outputs a second video setting information for individually setting brightness and tone according to an operation input. The menu screen adjustment module 622 and program table screen adjustment module 623 include a character information processing module. The video processing module 55 displays the dynamic image content signals by using the first video setting information, and displays the image information signal by using the second video setting information.

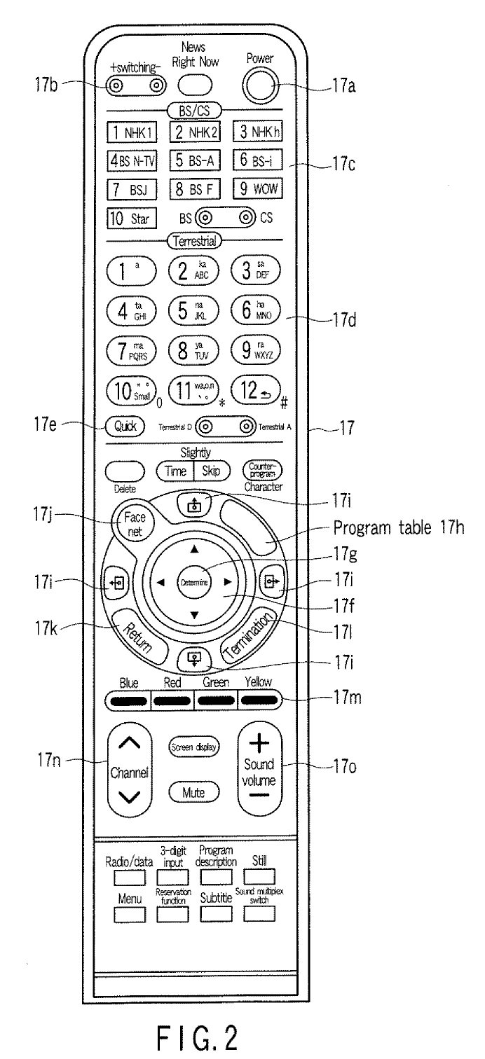

FIG. 2 shows the external view of the remote controller 72. The remote controller 72 mainly comprises a power key 17a, input switching keys 17b, satellite digital broadcast channel direct tuning keys 17c, terrestrial broadcast channel direct selection keys 17d, a quick key 17e, a cursor key 17f, a determine key 17g, a program table key 17h, page switching keys 17i, a face net (navigation) key 17j, a return key 17k, a termination key 17l, blue/red/green/yellow color keys 17m, a channel up/down key 17n, and a sound volume adjustment key 17o.

When the program table key 17h is pressed, a program table is displayed. When the termination key 17l is pressed, the display returns to an on-air state (video display of a channel selected at present).

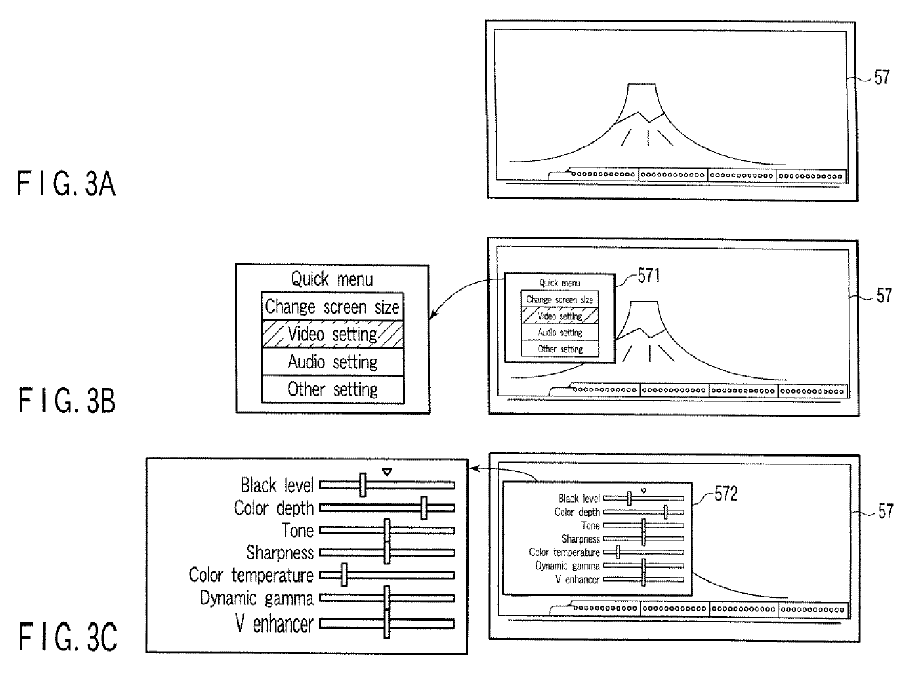

When the quick key 17e is pressed in the on-air state, a quick menu appears on an on-air screen of the display module 57, as shown in FIGS. 3A to 3C. FIG. 3A shows an on-air screen, and FIG. 38 shows a quick menu 571 appeared on an on-air screen. The menu includes items of “change screen size”, “vide setting”, “audio setting” and “other setting”. The user selects a desired item by operating the cursor key. In FIG. 3B, the cursor is moved to the “video setting”.

When the determine key is pressed in this state, adjustment items 572 appear as shown in FIG. 3C. The adjustment items include “black level”, “color depth”, “tone”, “sharpness”, “color temperature”, “dynamic gamma”, and “V enhancer”. The user moves the cursor to a desired item. For example, move a vertical bar indicating an adjustment position to the right or left by operating the page switching keys 171i (or the channel up/down key 17n).

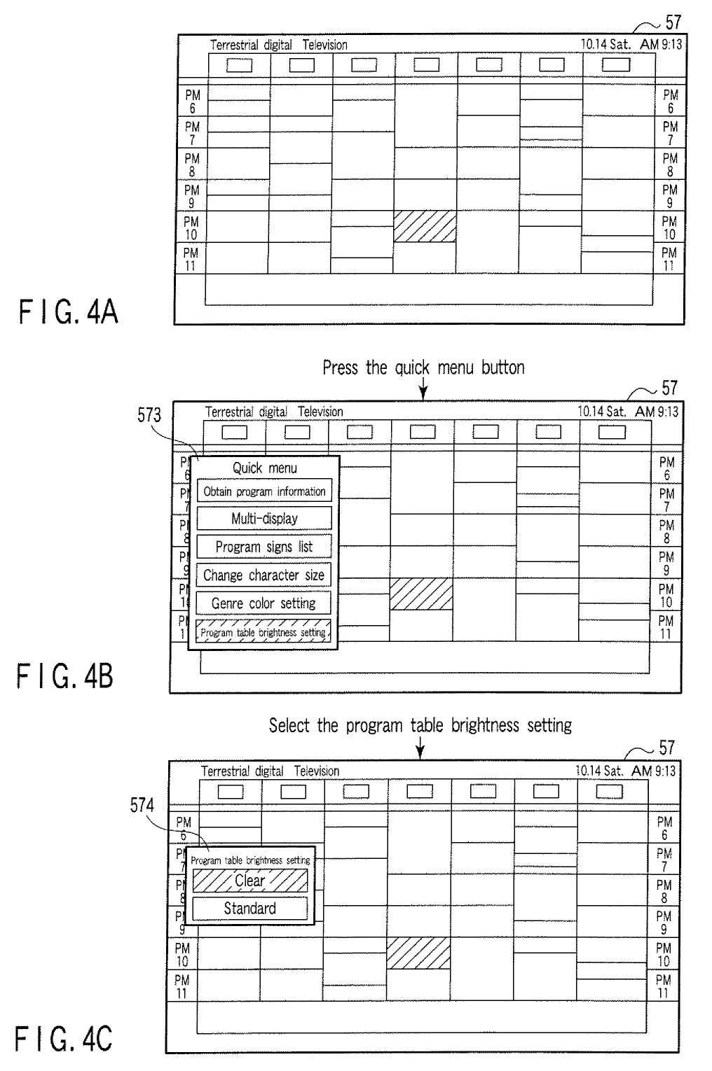

In the apparatus of the present invention, at least the brightness of a program table can be adjusted. On the screens shown in FIGS. 4A to 4C, the brightness of a program table can be adjusted.

In the program table display state, a program table is displayed, a type of broadcast (characters to identify terrestrial digital broadcast, analog broadcast, and satellite broadcast), and current date and time are displayed in the uppermost stage. As for the program table itself, time of broadcast is indicated in the vertical direction, and a broadcast channel is indicated in the horizontal direction. Program names and performers in each time are indicated by characters. The user can reserve recording of a program by moving the cursor to a desired program name.

At first, the user presses the program table key 17h. A program table appears as shown in FIG. 4A. The, the user moves the cursor up, down or to the left/right boundary position. The screen is scrolled. The user can display the next time zone, channel or program name.

When the quick key 17e is pressed in the state of FIG. 4A, a quick menu 573 for a program table appears as shown in FIG. 4B. The Quick menu 573 includes “get program information”, “multi-display”, “program signs list”, “change character size”, “genre color setting”, and “program table brightness setting”.

If the “program table brightness setting” is selected, further adjustment items “clear” and “standard” appear. The user moves the cursor to a desired item, and operates the page switching keys 17i (or the channel up/down key 17n). Then, the screen responds to the operation, and changes. The “program table brightness setting” is selected in FIG. 4B. The user presses the determine key when a desired clearness is obtained. This adjusts and sets the display state specific to a program table. The video setting information sets brightness and tone in the video processing module 55 for a video signal of program table information input to the OS signal generation module 54. The video setting information is stored in the nonvolatile memory 613 so as too be used when the program table is displayed next time.

The nonvolatile memory 613 stores standard setting information as video setting information for a program table. The standard setting information is previously stored in a factory as optional information.

In the above explanation, there are two adjustment items, “clear” and “standard” as shown in FIG. 4C. It is of course permitted to adjust “black level”, “color depth”, “tone”, “sharpness” and “color temperature” as shown in FIG. 3C.

Further, in the above explanation, the effect of video setting appears in the entire program table display. But, the effect is not limited to this. The video setting effect may appear in program information at the position selected by a rectangular cursor. This clarifies the user's interested item. In addition to this effect, the area selected by the rectangular cursor may be magnified (zoomed in), and the video setting effect may appear in this area.

The present invention is not limited to the embodiment described above. An automatic adjustment function may be provided to adjust brightness of a screen according to surrounding conditions.

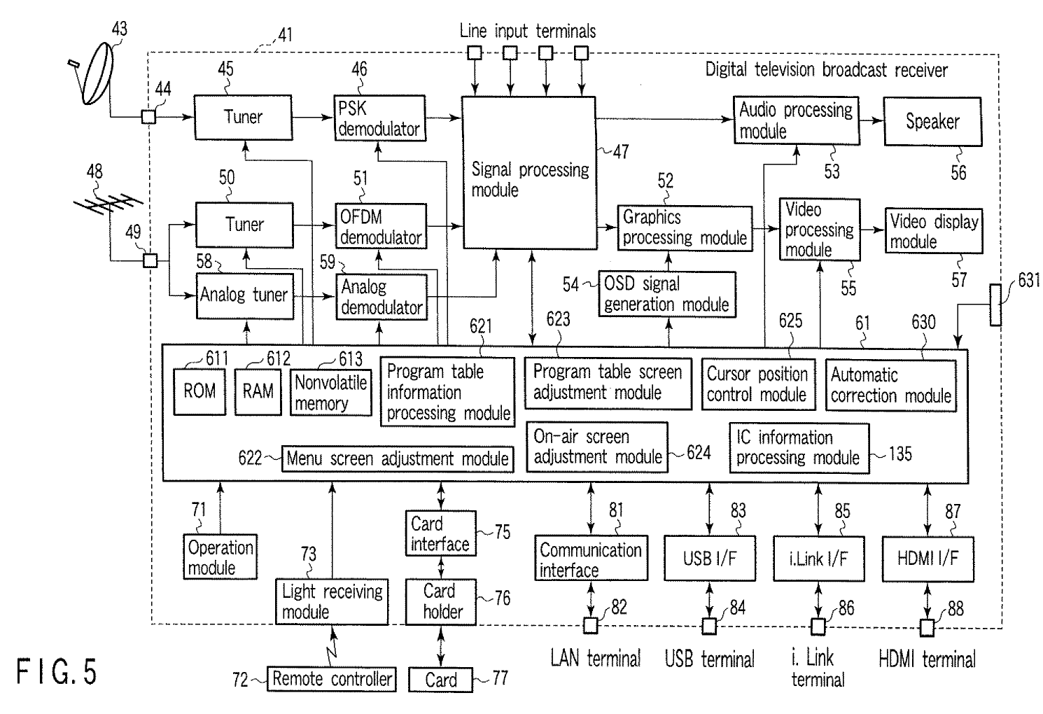

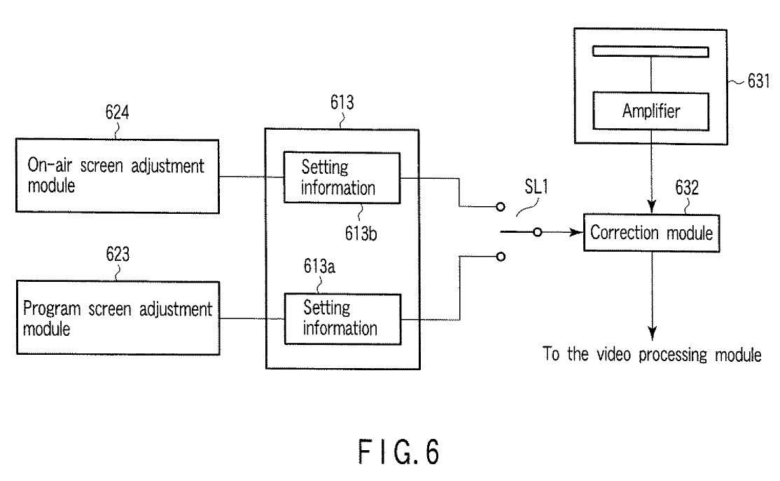

FIG. 5 shows a digital television broadcast receiver having a sensor 631 for detecting brightness in various surrounding conditions. A brightness-sensitive output of the sensor 631 is supplied to an automatic correction module 630 in the control module 61. The automatic correction module 630 has a relation to setting information as shown in FIG. 6.

In FIG. 6, the output of the sensor 631 is applied to the correction module 632. Setting information has been applied to the correction module 632 through a selector SL1. The setting information consists of the information stored it memory modules 613a and 613b. Namely, the memory modules 613a and 613b are ensured in the nonvolatile memory 613. The memory module 613a saves the setting information adjusted by the program table screen adjustment module 623. The memory module 613b saves the setting information adjusted by the on-air screen adjustment module 624. When an on-air program signal is displayed, the selector SL1 selects the setting information from the memory module 613b, and supplies it to the correction module 632. When a program table signal is displayed, the selector SL1 selects toe setting information from the memory module 613a, and supplies it to the correction module 632.

Therefore, the correction module 632 outputs corrected video setting information. In this case, also, optimum brightness and tone are independently set for an on-air program and a program table.

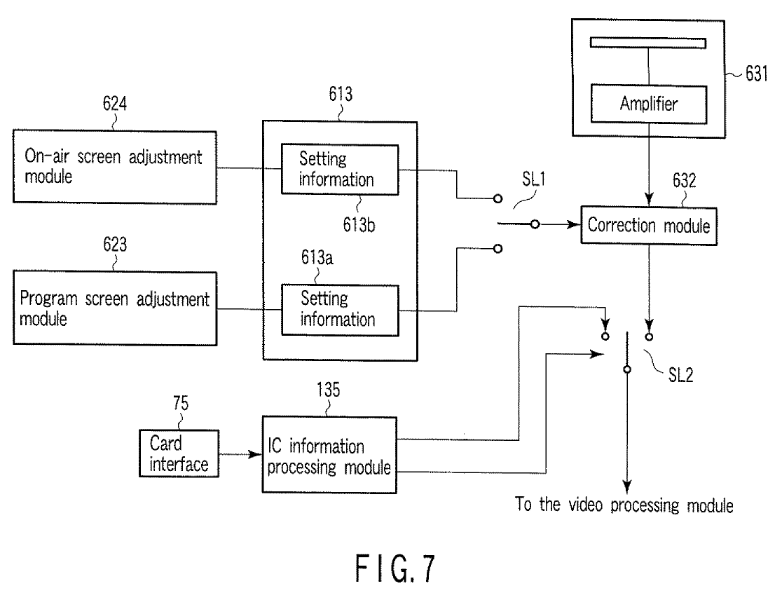

The present invention is not limited to the embodiment described above. A means for forcibly controlling a program table signal may be provided. FIG. 7 shows further embodiment. The output of the correction module 632 is applied to a selector SL2. The output of an IC information processing module 135 is also applied to the selector SL2. When a specific IC card is held in the IC holder, the IC information processing module 135 reads the information of this IC card. An IC card saves information to control a program table signal to a specific state, for example. When the EC card is recognized, the selector SL2 is controlled to forcibly select the output of the IC information processing module 135. The IC information processing module 135 also outputs a selector control signal. The output of the IC information processing module 135 is supplied to the video processing module through the selector SL2.

This function can be effectively used when the apparatus is installed in a particular environment, for example, when the apparatus is displayed in front of a store. When the apparatus is installed in front of a store, the apparatus may be placed in very bright outdoors. In such a case, normal brightness setting is insufficient for a program table and an on-air screen. Namely, the brightness must be controlled to brightness out of the ordinary setting range. In such a case, exceptional screen brightness control is possible by inserting the above-mentioned specific IC card into the card holder 76.

A program table is explained herein. However, in the present invention, similar video setting is possible for character data to form a text screen. Namely, character data can be obtained from data broadcast, and can be temporarily stored in a memory. Character data is displayed on a screen, when the user makes a display request. The display content includes a text screen, a weather forecast, stock information, etc. When the display is switched to any of this content, the individual setting of brightness and tone described herein is possible. A character, subtitle and menu may be included in the dynamic content signals reproduced from a recording medium (DVD, hard disc, etc.). They are output mainly through the OSD signal generation module. The present invention permits adjustment of brightness and tone independently for such a character, subtitle and menu. When both dynamic and static age content is displayed, the content may be adjusted by different kinds of video setting information. In this case, the static image content may be multiplexed with the dynamic image content, or the dynamic and static images may be switched and independently displayed.

While certain embodiments of the invention have been described, these embodiments have been presented by way of example only, and are not intended to limit the scope of the invention. Indeed, the novel method and system described herein may be embodied in a variety of other forms; furthermore, various omissions, substitutions and changes in the form of the method and system described herein may be made without departing from the spirit of the invention. The accompanying claims and their equivalents are intended to cover such forms or modifications as would fall within the scope and spirit of the invention.

What as claimed is:

1. A video signal processing apparatus comprising:
a first signal processing module configured to process dynamic inane content signal;
a second signal processing module configured to process static image content signal for multiplexing them with the dynamic image content signal or displaying them independently;
a first screen adjustment module configured to output first video setting information for video setting such as brightness and tone for the dynamic image content signal according to an operation input;
a second screen adjustment module configured to output second video setting information for individually setting brightness and tone according to an operation input; and
a video processing module configured to display the dynamic image content signal by using the first video setting information, and to display the image information signal by using the second video setting information.

2. A video signal processing apparatus comprising:
a first signal processing module configured to process dynamic image content signal;
a second signal processing module configured to output a video processing signal including a character to be multiplexed with the dynamic image content signal;
a first screen adjustment module configured to output first video setting information for video setting such as brightness and tone for the dynamic image content signal according to an operation input;
a second screen adjustment module configured to output second video setting information for individually setting brightness and tone according to an operation input; and
a video processing module configured to display the dynamic image content signal by using the first video setting information, and displays the image information signal by using the second video setting information.

3. The video signal processing apparatus of claim 2, wherein the dynamic image content signal is an on-air program signal obtained by demodulating and processing a signal received by a receiving module by a signal processing module, and
the video information signal including a character is a signal processed by a character information processing module.

4. The video signal processing apparatus of claim 3, wherein the character information processing module is a program table information processing module to process an electronic program information, and
the second screen adjustment module is a program table screen adjustment module.

5. The video signal processing apparatus of claim 4, further comprising a menu screen processing module configured to display individual setting items when the program table screen adjustment module performs video setting for the program table.

6. The video signal processing apparatus of claim 4, further comprising:
a setting information memory storing the second video setting information set by the program table screen adjustment module; and
a sensor which obtains environment information sensitive to surrounding brightness,
wherein the second video setting information is given to the video processing module as a control signal, after being corrected by the sensor output.

7. The video signal processing apparatus of claim 5, further comprising:
an IC information processing module which is input information from an IC card; and
a selector which selects third video setting information from the IC processing module,
wherein when the IC card is inserted, the third video setting information is forcibly selected and given to the video processing module as a control signal.

8. A controlling method of controlling a digital television broadcast receiver,
the digital television broadcast receiver having a receiving module which receives a broadcast signal, and obtains a receiving signal; a demodulating and signal processing module which demodulates and processes the receiving signal, and converts the signal to a displaying signal; a program information processing module which obtains broadcast program information, and creates information for displaying a program table; and an on-air screen adjustment module which outputs first video setting information for video setting such as brightness and tone for the displaying signal of the on-air program signal output from the modulating and signal processing module, according to an operation input, and a control module, the controlling method comprising
displaying the program table displaying signal output from the program information processing module; and
outputting second video setting information for video setting such as brightness and tone for the program table displaying signal according to an operation input.
